(19) United States
(12) Patent Application Publication
(10) Pub. No.: US 2015/0006756 A1
(43) Pub. Date: Jan. 1, 2015

(54) TRANSMISSION MANAGEMENT DEVICE, SYSTEM, AND METHOD

(71) Applicant: POWER-ALL NETWORKS LIMITED, SHATIN (HK)

(72) Inventor: STEVE LAP WAI HUI, Shatin (HK)

(21) Appl. No.: 14/315,591

(22) Filed: Jun. 26, 2014

(30) Foreign Application Priority Data
Jun. 27, 2013 (CN) 2013102617196

(51) Int. Cl. H04L 12/707

(52) U.S. Cl. CPC H04L 45/22
USPC 709/239

(57) ABSTRACT

A transmission management method includes detecting whether an electronic device is accessing a data network, the electronic device accesses the data network comprises viewing or downloading media files of the data network. A data size of a media file is detected when the electronic device is viewing or downloading the media file of the data network. The electronic device accesses the data network via a leased transmission path when the data size of the media file is greater than a predetermined value.

### CROSS-REFERENCE TO RELATED APPLICATIONS

This application claims priority to Chinese Patent Application No. 201310261719.6 filed on Jun. 27, 2013 in the China Intellectual Property Office, the contents of which are incorporated by reference herein.

1. “TRANSMISSION MANAGEMENT DEVICE, SYSTEM, AND METHOD” by Steve Lap Wai Hui, whose Attorney Docket No. is US52348.

2. “TRANSMISSION MANAGEMENT DEVICE, SYSTEM, AND METHOD” by Steve Lap Wai Hui, whose Attorney Docket No. is US52358.

3. “TRANSMISSION MANAGEMENT DEVICE, SYSTEM, AND METHOD” by Steve Lap Wai Hui, whose patent application Ser. No. is 14/278640, filed on May 15, 2014, related to a method for establishing a leased/optimal transmission path.

4. “TRANSMISSION MANAGEMENT DEVICE, SYSTEM, AND METHOD” by Steve Lap Wai Hui, whose patent application Ser. No. is 14/278640, filed on May 15, 2014, related to a method for establishing a leased/optimal transmission path.

5. “TRANSMISSION MANAGEMENT DEVICE, SYSTEM, AND METHOD” by Steve Lap Wai Hui, whose patent application Ser. No. is 14/278685, filed on May 15, 2014, related to a method for establishing a leased/optimal transmission path.

6. “TRANSMISSION MANAGEMENT DEVICE, SYSTEM, AND METHOD” by Steve Lap Wai Hui, whose patent application Ser. No. is 14/278704, filed on May 15, 2014, related to a method for establishing a leased/optimal transmission path.

### FIELD

The present disclosure relates to devices, and particularly to a transmission management device, a system, and a method thereof.

### BACKGROUND

Electronic devices, such as mobile phones and tablet computers, can have a variety of software installed thereon. Popular software installed on the electronic device can be social networking software. A user can share files with friends or other people via the social networking software, or view the files on line.

### BRIEF DESCRIPTION OF THE DRAWINGS

Implementations of the present technology will now be described, by way of example only, with reference to the attached figures.

FIG. 1 is a block diagram of an embodiment of a transmission management device.

FIG. 2 is a flowchart diagram of an embodiment of a transmission management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

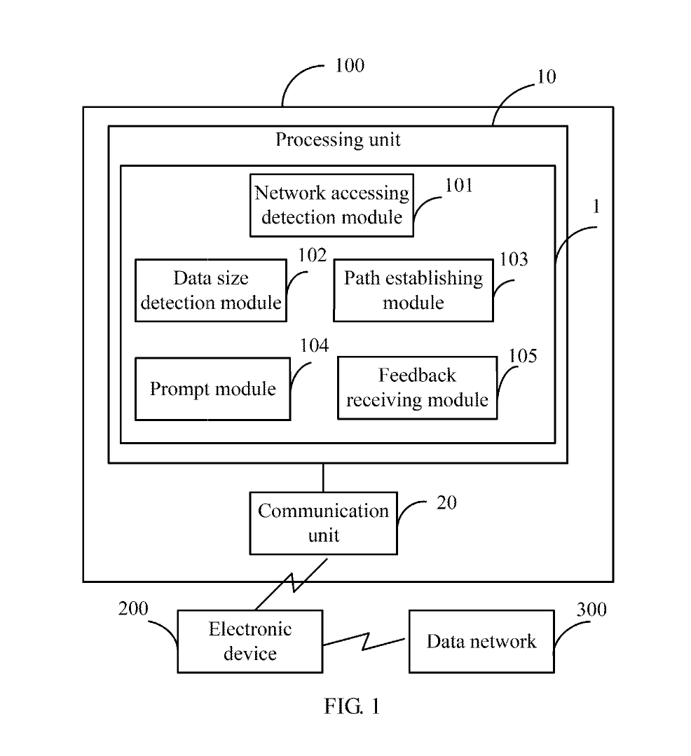

FIG. 1 illustrates a transmission management device 100 of the disclosure. The transmission management device 100 includes a processing unit 10 and a communication unit 20.

The transmission management device 100 connects to at least one electronic device 200 via the communication unit 20. The communication unit 20 connects the transmission management device 100 with the electronic device 200 via corresponding networks, such as, the Internet, a wireless network including WIFI and BLUETOOTH®, a telecommunication network including a general packet radio service (GPRS) network and a code division multiple access (CDMA) network, or a broadcasting network.

In the embodiment, the processing unit 10 runs a transmission management system 1. The transmission management system 1 includes a number of modules, which are a collection of software instructions and are executed by the processing unit 10 of the transmission management device 100. The modules include a network accessing detection module 101, a data size detection module 102, and a path establishing module 103. In the embodiment, the processing unit 10 can be a central processing unit, a digital signal processor, or a single chip, for example.

The network accessing detection module 101 is used to detect whether the electronic device 100 is accessing a data network 300. In the embodiment, the data network 300 is the Internet, the electronic device 100 accesses the data network 300, which can include viewing or downloading media files of the data network 300.

The data size detection module 102 is used to detect a data size of a media file being viewed/watched or downloaded by the electronic device 200 when the network accessing detection module 101 determines the electronic device 100 is playing or downloading the media file of the data network 300. The media file can be an audio file, a video file, a word file, or an image, for example.

The path establishing module 103 is used to provide a leased transmission path to the electronic device 200 and controls the electronic device 200 to access the data network 300 via the leased transmission path when the data size detection module 102 detects the data size of the media file is greater than a predetermined value, such as 100 Megabits.

In the embodiment, the leased transmission path can be an on-demand virtual lease line (ODVLL) and have a large network bandwidth and a high transmission speed. The path establishing module 103 providing the leased transmission path to the electronic device 200 establishes the leased transmission path between the electronic device 200 and a network server (not shown) of the data network 300. In more detail, the leased transmission path are constituted by a number of routers (not shown) connected between the electronic device 200 and the network server of the data network 300. The related technology of establishing the leased transmission path by the path establishing module 103 are disclosed in prior patent applications whose patent application Ser. Nos. are 14/278640, 14/278640, 14/278685, and 14/278704.

In the embodiment, the transmission management system 1 further includes a prompt module 104 and a feedback receiving module 105.

The prompt module 104 is used to transmit a prompt signal to the second electronic device 202 to prompt a user of the electronic device 200 to use the leased transmission path when the data size detection module 102 detects the data size of the media file being viewed or downloaded by the electronic device 200 is greater than the predetermined value.

The feedback receiving module 105 is used to receive a feedback signal from the second electronic device. In the embodiment, the feedback signal includes a reply to the prompt signal, such as “Yes” or “No”.

If the path establishing module 103 determines the user wants to use the leased transmission path according to the feedback signal, namely the feedback signal is “Yes”, the path establishing module 103 then provides the leased transmission path to the electronic device 200.

In other embodiments, the prompt module 104 and the feedback receiving module 105 can be omitted. Here, the path establishing module 103 is further used to cancel the leased transmission path provided to the electronic device 200 when the media file has been viewed or completely downloaded by the electronic device 200. In the embodiment, the path establishing module 103 further records a start time when providing the leased transmission path and an end time when cancelling the leased transmission path.

In another embodiment, the prompt signal produced by the prompt module 104 further includes a prompt for selecting the start time for providing the leased transmission path and the end time for cancelling leased transmission path. In addition, the feedback signal received by the feedback receiving module 105 further includes the start time and the end time selected by the user of the electronic device 200. Therefore, the path establishing module 103 can establish the leased transmission path when a current time reaches the start time selected by the user and cancel the leased transmission path when the current time reaches the end time selected by the user.

Thus, when the data size of the media file is huge, such as greater than 10 Megabits, the present disclosure can provide the leased transmission path to download or play the media file, which enhances the transmission speed.

In the embodiment, the transmission management device 100 can be a server of a network operator.

In another embodiment, the transmission management device 100 can be a server of a social network application. When the electronic device 200 viewes or downloads the media files via the social network application, the modules of the transmission management system 1 execute the above functions to enhance the access speed.

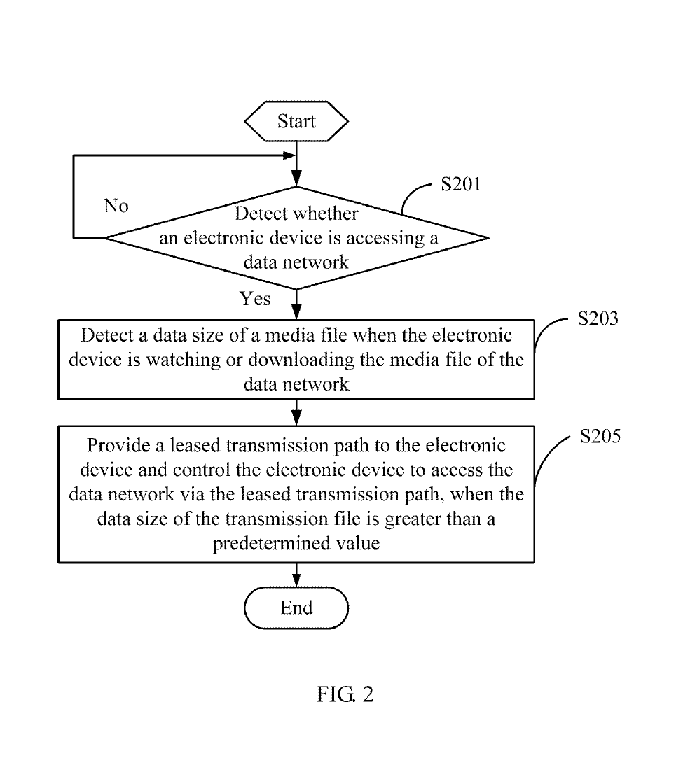

FIG. 2 illustrates a flowchart of a transmission management method. In block 201, a network accessing detection module detects whether an electronic device is accessing a data network. If yes, the process goes to block 203, if no, the process returns to block 201.

In block 203, a data size detection module detects a data size of a media file being viewed or downloaded by the electronic device.

In block 205, a path establishing module provides a leased transmission path to the electronic device and controls the electronic device to access the data network via the leased transmission path, when the data size detection module detects the data size of the media file is greater than a predetermined value.

In one embodiment, the method further includes: a prompt module transmits a prompt signal to the second electronic device to prompt a user of the electronic device to use the leased transmission path when the data size detection module detects the data size of the media file being viewed or downloaded is greater than the predetermined value; and a feedback receiving module receives a feedback signal from the second electronic device. If the path establishing module determines the user wants to use the transmission path according to the feedback signal, namely when the feedback signal is “Yes”, the path establishing module then provides the leased transmission path to the electronic device.

In another embodiment, the method further includes: the path establishing module records a start time when providing the leased transmission path and an end time when cancelling the leased transmission path.

In another embodiment, the prompt signal produced by the prompt module further includes a prompt for selecting the start time for providing the leased transmission path and the end time for cancelling the leased transmission path, and the feedback signal received by the feedback receiving module further includes the start time and the end time selected manually. The method further includes steps: the path establishing module establishes the transmission path when a current time reaches the start time selected by the user and cancels the transmission path when the current time reaches the end time selected by the user.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission management system, applied to a transmission management device comprising a communication unit for connecting to at least one electronic device, the transmission management system comprising:
a processing unit; and
a plurality of modules which are collections of instructions executed by the processing unit, the modules comprising:
a network accessing detection module configured to detect whether an electronic device is accessing a data network, wherein the electronic device accesses the data network comprises viewing or downloading media files of the data network;
a data size detection module configured to detect a data size of a media file when the network accessing detection module determines the electronic device is viewing or downloading the media file of the data network; and
a path establishing module configured to provide a leased transmission path to the electronic device and control the electronic device to access the data network via the leased transmission path when the data size detection module detects the data size of the media file is greater than a predetermined value.

2. The system according to claim 1, wherein the path establishing module is further configured to cancel the leased transmission path provided to the electronic device when the media file is viewed or downloaded by the electronic device completely.

3. The system according to claim 2, wherein the path establishing module is further configured to record a start time when providing the leased transmission path and an end time when cancelling the leased transmission path.

4. The system according to claim 1, wherein the transmission management system further comprises a prompt module and a feedback receiving module; the prompt module is configured to transmit a prompt signal to the electronic device to prompt a user of the electronic device whether to use the leased transmission path when the data size detection module detects the data size of the media file is greater than the predetermined value; the feedback receiving module is configured to receive a feedback signal from the electronic device; and the path establishing module provides the leased transmission path to the electronic device when determining the user want to use the leased transmission path according to the feedback signal.

5. The system according to claim 4, wherein the prompt signal produced by the prompt module further comprises a prompt for selecting the start time for providing the leased transmission path and the end time for cancelling the leased transmission path; the feedback signal received by the feedback receiving module further comprises the start time and the end time selected by the user of the electronic device; and the path establishing module is further configured to provide the leased transmission path when a current time reaches the start time selected by the user and cancel the leased transmission path when the current time reaches the end time selected by the user.

6. A transmission management device comprising:
a communication unit configured to communicate with at least one first electronic device and at least one second electronic device; and
a processing unit configured to execute a plurality of modules which are collection of instructions, the modules comprising:
a network accessing detection module configured to detect whether an electronic device is accessing a data network, wherein the electronic device accesses the data network comprises viewing or downloading media files of the data network;
a data size detection module configured to detect a data size of a media file when the network accessing detection module determines the electronic device is viewing or downloading the media file of the data network; and
a path establishing module configured to provide a leased transmission path to the electronic device and control the electronic device to access the data network via the leased transmission path when the data size detection module detects the data size of the media file is greater than a predetermined value.

7. The device according to claim 6, wherein the path establishing module is further configured to cancel the leased transmission path provided to the electronic device when the media file is viewed or downloaded by the electronic device completely.

8. The device according to claim 7, wherein the path establishing module is further configured to record a start time when providing the leased transmission path and an end time when cancelling the leased transmission path.

9. The device according to claim 6, wherein the transmission management system further comprises a prompt module and a feedback receiving module; the prompt module is configured to transmit a prompt signal to the electronic device to prompt a user of the electronic device whether to use the leased transmission path when the data size detection module detects the data size of the media file is greater than the predetermined value; the feedback receiving module is configured to receive a feedback signal from the electronic device; and the path establishing module provides the leased transmission path to the electronic device when determining the user want to use the leased transmission path according to the feedback signal.

10. The device according to claim 9, wherein the prompt signal produced by the prompt module further comprises a prompt for selecting the start time for providing the leased transmission path and the end time for cancelling the leased transmission path; the feedback signal received by the feedback receiving module further comprises the start time and the end time selected by the user of the electronic device; and the path establishing module is further configured to provide the leased transmission path when a current time reaches the start time selected by the user and cancel the leased transmission path when the current time reaches the end time selected by the user.

11. A transmission management method comprising:
detecting whether an electronic device is accessing a data network, wherein the electronic device accesses the data network comprises viewing or downloading media files of the data network;
detecting a data size of a media file when the electronic device is viewing or downloading the media file of the data network; and
providing a leased transmission path to the electronic device and controlling the electronic device to access the data network via the leased transmission path, when the data size of the media file is greater than a predetermined value.

12. The method according to claim 11, further comprising:
cancelling the leased transmission path provided to the electronic device when the media file is viewed or downloaded by the electronic device completely.

13. The method according to claim 12, further comprising:
recording a start time when providing the leased transmission path and an end time when cancelling the leased transmission path.

14. The method according to claim 12, further comprising:
transmitting a prompt signal to the electronic device to prompt a user of the electronic device whether to use the leased transmission path when the data size of the media file is greater than the predetermined value;
receiving a feedback signal from the electronic device; and
providing the leased transmission path to the electronic device when determining the user want to use the leased transmission path according to the feedback signal.

15. The method according to claim 14, wherein the prompt signal produced by the prompt module further comprises a prompt for selecting the start time for providing the leased transmission path and the end time for cancelling the leased transmission path, and the feedback signal received by the feedback receiving module further comprises the start time and the end time selected by the user of the second electronic device; the method further comprises:
providing the leased transmission path when a current time reaches the start time selected by the user and cancelling the leased transmission path when the current time reaches the end time selected by the user.
